(19) United States
(12) Patent Application Publication
(10) Pub. No.: US 2005/0252113 A1
(43) Pub. Date: Nov. 17, 2005

(54) Sandwich structure

(76) Inventors: Jean-Christopher Duclos, Arthun (FR); Gerard Martin, Villemoble (FR)

Correspondence Address: MCDERMOTT, WILL & EMERY (LOS ANGELES OFFICE), 2049 CENTURY PARK EAST, 34TH FLOOR, LOS ANGELES, CA, 90067-3208, US

(21) Appl. No.: 10/522,075

(22) PCT Filed: Jul. 21, 2003
(86) PCT No.: PCT/FR03/02305

§ 371 Date: May 12, 2005

(30) Foreign Application Priority Data
Jul. 24, 2002 (FR) 0209381
Nov. 5, 2002 (FR) 0213809

(51) Int. Cl. E06B 3/28

(52) U.S. Cl. 52/203

(57) ABSTRACT

A sandwich structure for protecting a fixed or mobile installation or equipment, comprising an inner layer (1) and an outer plate (2) made of a very ductile material, fixed at a distance from the inner layer (1) and designed to resist the first impacts of projectiles, the inner layer (1) being made from a very hard material to stop projectiles that passed through the outer plate, the outer plate (2) having a constant thickness and being fixed on the inner layer (1) using spacers (7, 7′, 13, 14).

This invention relates to a sandwich structure element to protect equipment against external aggression and particularly against projectile impacts.

It is particularly but not exclusively applicable to fixed or mobile installations and equipment such as land, sea or air vehicles, containers, packaging, etc.

A sandwich structure for vehicles with medium protection has already been proposed. This type of vehicle usually includes a survival cell composed of an assembly of welded steel plates covered on the inside of the cell by internal plates made of a material such as aluminum.

It is found that this solution has several disadvantages. Firstly, placement of plates inside the cell is difficult, particularly due to the presence of equipment that in some cases has to be circumvented. The result is discontinuities in protection of the cell.

Moreover, an aluminum plate tends to break into fragments when it is subjected to a shockwave, which can sometimes cause projections of splinter. To prevent such splinter torn from internal plates from being projected onto occupants of the cell, the inner plates are covered by a protective layer usually composed of plates made of a composite material.

These protection plates are made and adapted to the shape of the cell to be protected using a press. There are very few manufacturers of such plates, which causes procurement problems.

Furthermore, when repairing an armored vehicle that has been subjected to impacts that have damaged the inner plates, the protective layer needs to be removed and in some cases internal equipment has to be disassembled so that the damaged inner plates can be removed to replace them. The result is long repair times that correspondingly reduce the operational availability of the vehicle.

Patent DE 197 40 103 describes a vehicle bottom armor, particularly against mines, composed of an outer layer of light metal, and an inner layer of steel armor. The lightweight metal layer has ribs facing the inner layer, which are in contact with the inner layer such that the outer layer is held at a distance from the inner layer. It is found that these ribs make the outer layer completely rigid and therefore it is impossible to shape it to protect the curved surfaces of a vehicle. Furthermore, these ribs impose specific manufacturing of the outer layer necessitating special moulds. Therefore, this also causes risks of procurement difficulty.

Patent FR 865 964 describes armor composed of two layers held at a spacing from each other by springs. This structure is not very efficient because it makes it impossible to benefit from a beam effect that occurs when the outer plate is rigidly fixed to the inner layer.

The purpose of this invention is to eliminate these disadvantages. This purpose is achieved by providing a sandwich structure . . . (copy claims here for legal reasons).

One preferred embodiment of the invention will be described below as a non-limitative example, with reference to the appended figures, wherein:

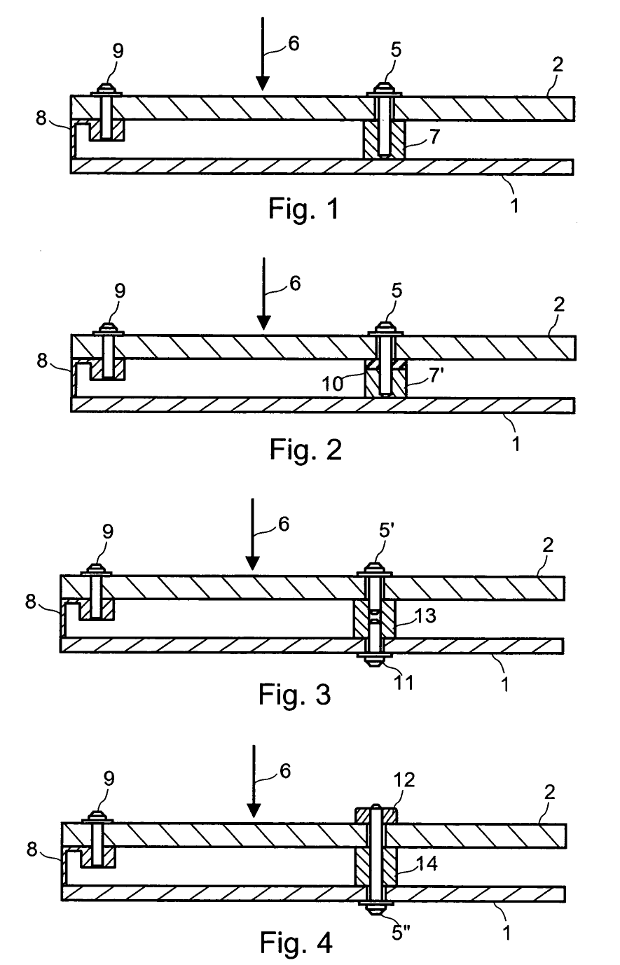

FIG. 1 diagrammatically shows a section through the sandwich structure according to this invention;

FIGS. 2 to 4 show a section through other variants of the sandwich structure according to the invention shown in FIG. 1.

The protection against projectile impacts from vehicles with low protection is usually placed inside the vehicle bodywork. The protection elements in the invention are placed outside the vehicle bodywork, contrary to this principle.

Thus, as shown in FIG. 1, the vehicle bodywork usually made of an assembly of steel plates 1, in other words a very hard material, is covered on the outside by protection plates 2 made of a very ductile material such as aluminum. The arrow 6 shows the displacement direction of a projectile.

The two layers 1, 2 of the sandwich structure are kept separate from each other, mechanically fixing the protection plates 2 at a distance from the bodywork 1. The distance between the two layers is determined as a function of the nature of projectiles to be stopped.

This spacing is obtained using spacers 7, which are for example welded to the bodywork 1. In order to fix the protection plates 2, these spacers are for example drilled by a threaded bore to hold the protection plate attachment screws 5.

The steel plates 1 making up the bodywork have a thickness of the order of a few millimeters. The protection plates 2 made of aluminum have a thickness of the order of 10 mm or more, depending on the type of projectile to be stopped, and the spacing between these two layers is of the order of one to several tens of millimeters, also depending on the type of projectile to be stopped.

Since the bodywork 1 and the protection plates 2 are made from different materials, the assembly is affected by differential expansion when the temperature changes. Therefore at least some of the bores made for the passage of screws 5, preferably in the protection plates 2, are oblong.

Preferably, the bodywork is provided with angles 8 that may for example be welded along their edge, preferably on the edges of the plates 1 making up the bodywork. These angles 8 are each provided with a threaded bore, designed to hold an attachment screw 9 fixing a protection plate 2. These angles provide electrical continuity between the plates 1 of the bodywork and the protection plates 2, for anti-interference purposes. They are preferably flexible to enable differential dilatations.

The connection between the two layers 1, 2 of the structure is also preferably elastic to enable differential dilatations. This is achieved by inserting an elastic layer 10 between the spacer 7′ and the protection plate 2 (FIG. 2).

This elastic layer also dampens vibrations generated by a projectile impact and provides insulation against a galvanic couple while enabling a wider assembly tolerance.

According to one preferred embodiment of the invention as shown in FIG. 3, the spacers 13 have a tubular shape in which the central bore is fully threaded, the two layers 1, 2 being drilled to hold screws 5′, 11 that screw onto each side of the spacer in the central bore.

According to another variant of the invention as shown in FIG. 4, the spacers 14 can also be in a tubular shape, the two layers 1, 2 being drilled to hold a single screw 5″ passing firstly through one of the two layers, then through the spacer, then through the other layer to be screwed into a nut 12. Advantageously, the bore passing through the spacers 14 is threaded so that the spacers can be fixed on the bodywork before the protection plate 2 is installed.

The sandwich structure described above very surprisingly provides a significantly better protection than when the protection plates 2 are placed inside the bodywork, and particularly a significantly better protection to mass ratio. In fact, the first ductile barrier (aluminum protection plate 2) fixed at a distance from the bodywork provides a beam effect that absorbs some of the kinetic energy of the projectile, while the second barrier (the steel plates 1 of the bodywork) with very high hardness stops the projectile that has lost some of its energy.

Since there is not very much large equipment outside the vehicle, the protection plates 2 can cover the entire bodywork of the vehicle, which gives excellent protection uniformity.

Furthermore, the sandwich structure according to the invention has a significantly lower implementation cost than solutions according to prior art, since it is no longer necessary to provide plates for protection against splinter since the bodywork performs this function. Furthermore, it is very much easier to place protection plates 2 since these plates can be placed without needing to disassemble any equipment. The result is an armored vehicle that can be repaired more quickly after an impact simply by exchanging damaged protection plates that are mounted on the outside of the vehicle, such that the vehicles with this type of protection have a much higher operational availability.

The invention can also significantly simplify the procurement of protection elements since aluminum protection plates are simple plates with no particular machining and with constant thickness. Therefore they can be obtained from a larger number of manufacturers than protection plates according to prior art, which have a specific shape adapted to a particular vehicle type.

Due to their constant thickness and their high ductility, the protection plates can also be easily curved, for example to be adapted to the shapes of a vehicle bodywork.

The tests carried out show that the sandwich structure described above is very efficient against perforating projectiles with a velocity of more than 650 m/s.

1. A sandwich structure for protecting a fixed or mobile installation or equipment, said sandwich structure comprising an inner layer and an outer plate made of a very ductile material, fixed at a distance from the inner layer and designed to resist the first impacts of projectiles, the inner layer being made from a very hard material to stop projectiles that passed through the outer plate, the outer plate having a constant thickness and being fixed on the inner layer using spacers.

2. The sandwich structure according to claim 1, wherein elastic elements are inserted between each spacer and the outer plate to resist differential dilatations between the outer plate and the inner layer and to dampen vibrations generated by an impact.

3. The sandwich structure according to claim 1, further comprising conducting elements placed between the outer plate and the inner layer to provide electrical continuity between the plates.

4. The sandwich structure according to claim 1, wherein the spacing between the outer plate and the inner layer is of the order of one to a few tens of millimeters.

5. The sandwich structure according to claim 1, wherein the inner layer is made of steel and the outer plate is made of aluminum.

6. The sandwich structure according to claim 1, wherein each spacer is provided with a threaded bore, designed to hold an attachment screw fixing the outer plate onto the spacer.

7. The sandwich structure according to claim 1, wherein each spacer is provided with a threaded bore, designed to hold an attachment screw fixing the spacer onto the inner layer and an attachment screw fixing the outer plate onto the spacer.

8. The sandwich structure according to claim 1, wherein each spacer has a tubular shape.
